(19) United States
(12) Patent Application Publication
(10) Pub. No.: US 2004/0051723 A1
(43) Pub. Date: Mar. 18, 2004

(54) Method and device for displaying an image composed of pixels

(76) Inventor: Jurgen Kohn, Aalen (DE)

Correspondence Address: Charles N J Ruggiero, Ohlandt Greeley Ruggiero & Perle, 10th Floor, One Landmark Square, Stamford, CT, 06901-2682, US

(21) Appl. No.: 10/432,317

(22) PCT Filed: Nov. 20, 2001
(86) PCT No.: PCT/EP01/13386

(30) Foreign Application Priority Data
Nov. 21, 2000 (DE) 100 57 828.4

(51) Int. Cl. G09G 5/10

(52) U.S. Cl. 345/690

(57) ABSTRACT

The invention relates to a method for the size-adjusted display of a digital document on pixel-oriented output device, comprising the following steps: the output picture data of the digital document to be displayed which are stored in a digital storage medium and comprise predetermined dimensional data for displaying the digital document in a predetermined size are read into a main memory; the dimensional data of the desired output format of the digital document to be displayed on the output device as a target picture, with the dimensional data being stored in the storage medium, are read into the main memory; the predetermined dimensional data of the digital document and the dimensional data of the desired output format are processed by means of at least one computer unit interconnected with the main memory, and a scaling factor is produced depending on said dimensional data; the predetermined dimensional data in the output picture data are multiplied with the scaling factor by means of the computer unit, and the thus modified output picture data are stored as target picture data in the main memory or any other storage medium; the target picture data are transmitted to the output device and the digital document is displayed according to the target picture data on the output device; the dimensional data of the desired output format are checked recurrently in intervals; in the case of changed dimensional data the scaling factor is newly generated and the target picture data are newly calculated and the digital document is displayed again.

The invention relates to a method and an apparatus for displaying a picture made of pixels on a pixel-oriented output apparatus. The invention relates especially to the graphic display of a document present in digital form which is known to the person skilled in the art as a digital document.

The display of pictures composed of pixels, despite a large range of different monitor technologies, is the basis of all displays of information in the form of pictures. The pictures are composed of individual, successively arranged pixels, which means that a certain number of picture information leads to a certain size of the picture.

The picture information per see does not already have to be present in pixel format, but it can be information used for displaying a pixel-oriented picture such as an internet document. The entire information can be gained from such an internet document which is necessary in order to produce the illustrated picture composed of pixels. The processing of the information file, e.g. a hypertext document, usually occurs by means of a respectively set up computer device.

In our time of far-reaching networking of a large number of different technical systems such as computer systems, databases, mobile phones, ATMs or other systems, there are efforts to store data and information as centrally as possible so that they can be retrieved universally from any place, can be used universally and can be displayed on an output medium or an output device. Special importance is given to the world-wide networking by the internet (world-wide web or WWW).

The display of the information or data in such a network occurs as a picture which is provided in a pixel-oriented fashion on the output medium or the output device. The data comprise a certain information density of picture data, so that the display is bound to a fixed picture size, i.e. a certain number of pixels. The large number of output devices comprises a plurality of size formats, e.g. differently large screens of PCs or workstations (usually 14 inch to 21 inch of screen diagonally), displays or display devices of hand-held computers, laptops/notebook computers or even displays of mobile phones or PDAs (Personal Digital Assistants). Even with a single display device of a personal computer the actual display may be desirable or necessary in different size formats, e.g. when the user wishes to display the picture in a window on the desktop of his or her computer (i.e. a certain region of the screen surface), uses different window sizes and thus predetermines a certain display surface area for the picture on his or her screen.

In order to compensate for this deviation between centrally stored information which demands a predetermined picture size and the desired output size of the information as a picture, it is common practice nowadays to proceed as follows:

1. The output picture is smaller than the picture area on which this picture is to be displayed;

2. the output picture is larger than the picture area on which this picture is to be displayed.

In the first case the output picture will be displayed in its original size and the remaining border will be filled in the picture area with one color or with a pattern. In the second case a so-called scroll bar will be provided at the edge of the display area and display on the remaining picture area a section of the original picture according to the size of the picture area. The scroll bar then allows moving over the original picture (namely to scroll the same), meaning that the original picture is displaced behind the visible section, so that an adjoining section is displayed.

In both cases it is still possible to leave unchanged the size of individual elements incorporated in the initial picture (1:1) and to distribute these individual elements in the picture area available for outputting. In the first case this display technique obviously has limits concerning a minimum required picture area.

This way of displaying a picture made of pixels on a pixel-oriented output device is disadvantageous because the overall appearance of the picture and thus the information to be displayed is impaired and the viewer is unable to decide freely the size in which he or she wishes to view the entire picture, meaning the size with which the entire picture is displayed.

In order to enable the display of centrally stored picture information on different output devices in a suitable manner, systems are further known which convert the picture information prior to the output in a manner according to the features of the output device. It is thus possible to ensure that it is possible to omit the storage of different sets of picture information next to one another, whereby different sets are stored for different output devices. These systems use databases which determine which type of output device offers which type of display possibilities. When picture information is to be output to a specific output device, it is determined with the help of the database which individual picture objects or parameters need to be changed in which way to ensure that an error-free display on the specific output device is possible. The disadvantageous aspect in such systems which use databases is that following the introduction of an ever-increasing number of new output devices on the market these databases need to be updated continually in order to allow an error-free output on newly-developed output devices as well.

Moreover, the known systems are in need of further improvements concerning the dynamics of size-adjusted display. When an internet page is displayed in a browser window on a desktop of a PC, the user should be enabled at all times to change the size of the browser window (e.g. by drawing the frame of the browser window with a graphical input device), whereby the internet page displayed in the window should slide along as fluidly as possible without impairing the overall impression.

It is the object of the present invention to avoid the mentioned disadvantages of the state of the art and to provide a method and an apparatus with which a picture composed of pixels can be displayed in any desired size irrespective of the size of the output picture or the output picture data which predetermine a certain size. The method and apparatus are characterized by a simple structure and low consumption of processing power and memory usage. In particular, the dynamic display of centrally stored picture information or a digital document is to be enabled in a simple, effective way on a large number of different display devices.

This object is achieved by the independent claims. The dependent claims describe especially advantageous embodiments of the invention.

The method in accordance with the invention allows achieving a display in an especially simple way of picture information as a picture on an output device, which display is random concerning the size and which can be predetermined freely and be changed at will by the user. The method allows for special dynamics, namely in such a way that a change in the size of the display area is possible at all times and leads to a direct size adjustment of the displayed picture without any disadvantageous effects on the overall visual impression.

In the process in accordance with the invention, the output picture data of a document present in digital form, i.e. a digital document, are read into a main memory. The output picture data comprise dimensional data of the digital document which are necessary for displaying the digital document in a predetermined size, e.g. predetermined height and width of the overall picture to be displayed.

According to the method in accordance with the invention, the dimensional data of the desired output format are further read into the main memory. The output format corresponds to the picture size with which the picture is to be displayed on the output device.

The dimensional data of the output picture or the digital document and the dimensional data of the target picture are processed by means of at least one computer unit interconnected to the main memory and a scaling factor is produced depending on the dimensional data.

The computer unit is used to multiply the dimensional data in the output picture data with the scaling factor. They are stored as target picture data in the main memory or any other storage medium. Through this process the output picture size is adjusted to the desired target picture size and a modified digital document is produced from the originally entered digital document.

The target picture data are sent to the output apparatus and the target picture is displayed according to the target picture data on the output device.

According to the method in accordance with the invention, the dimensioning data of the output format, and the output window in particular, are checked in regular intervals. When the dimensional data change, the scaling factor is newly generated and the target picture data are newly calculated from the output picture data. In this process, both previously calculated target picture data can be used as new output picture data as well as the original output picture data. The checking in recurrent intervals does not have to occur regularly, but a regular monitoring of the dimensional data of the desired output format is advantageous.

The invention thus allows a dynamic display of the picture on the output device. A user can intervene at all times and change the dimensional conditions of the region in which the picture is to be displayed. As a result of the verification of these dimensional parameters of the display in predetermined intervals, it is possible for example to enlarge or reduce an internet page displayed on the desktop of the computer in such a way that the overall impression of the displayed internet page is not impaired.

The method in accordance with the invention is especially suitable for displaying an internet page. An internet page is usually stored on a computer system which is called a web-server. A user of an individual PC, which is known as the client computer, who wishes to download such an internet page from the web-server and to display it on the output device of his or her PC usually uses a so-called web-browser or internet browser. An internet browser receives data or information from the web-server, namely the so-called internet page or a so-called internet document, via an established link especially via a telecommunications line between the client computer and the server system of an internet provider. The internet page comprises information for displaying a pixel-oriented picture and is frequently encoded by means of a special code, in particular by means of the so-called Hypertext Markup Language (HTML). This special code comprises individual data blocks, the so-called HTML tags. Every HTML tag comprises the output picture data of an area of the entire picture, i.e. a partial section of the internet page or a graphic object embedded in the internet page. These output picture data comprise dimensional data and in particular the picture height and width which determine the size of the output picture.

The output picture data especially comprise information blocks or, in the case of pictures which are embedded in HTML, HTML tags which define individual interactive elements such as interactive links or pushbuttons. These elements can be dynamic or intelligent, i.e. they can respond to certain entries or cause the execution of certain applications by the PC.

The dimensioning data of the desired output format on the output device can especially comprise window data of an internet browser. These window data preferably comprise the height and the width of the picture area of the window in which the output picture is to be displayed.

In an especially advantageous embodiment of the method in accordance with the invention; the scaling factor is generated depending on the picture height and the picture width of the output picture and the picture height and picture width of the picture area of the window of the internet browser. If the output picture data comprise dimensional data with a picture width of 800 pixels and a picture height of 600 pixels and the dimensional data of the target picture comprise a picture width of 1024 pixels and a picture height of 768 pixels, the scaling factor can be calculated by (1024×768)/(800×600)=1.6384. The scaling factor can also be calculated, when the same dimensional data are predetermined, only depending on the picture widths 1024/800=1.28 or the picture heights 768/600=1.28. It is obvious that other dimensions can be included in the calculation. Especially the proportions of the output picture can be maintained by a suitable calculation of the scaling factor or, if desired, also be influenced in a purposeful way.

The output picture data are advantageously read in a serial manner into the main memory, i.e. data block by data block or HTML tag by HTML tag. The read data block or HTML tag is checked for scalable variables and all scalable variables are multiplied with the scaling factor and replaced by the result of this multiplication. The thus modified data block is then sent to the internet browser and processed or translated by means of the internet browser, such that the picture to be displayed is assembled bit by bit. It is obviously also possible to first read in all data blocks and the HTML tags in particular, to check them for scalable variables, to scale the variables and then to send the data blocks to the internet browser, so that the picture to be displayed is built up within a short period of time.

As in this embodiment all scalable variables are multiplied with the same scaling factor, it is ensured that the impression of the internet page as is desired by the author of the internet page is not altered by changing the picture size. This characterizes the method as opposed to the known methods which merely take up individual objects of the internet page and convert them, so that the overall impression of the picture is impaired.

In an embodiment of the method in accordance with the invention, the scaling of the output picture data can occur on the network side of the internet server. This means the scaling factor and the target picture data are produced in particular by means of the computer unit of the internet server and transmitted to the client computer. The transmitted target picture data are displayed by means of the client computer on the output device linked to the client computer, especially by means of an internet browser which is installed on the client computer. The interposing of a so-called proxy server between the internet server and the client computer is possible. The output picture data or the digital document are advantageously stored on the internet server and the scaling factor or the target picture data are produced by means of the proxy server. The display of the modified digital document then also occurs by means of the client computer from which the dimensional data of the desired output format was received by the proxy server.

The scaling factor and the target picture data can also be produced on the network side of the client computer, especially by means of the client computer's computer unit, and be stored in the main memory or any other storage medium which is connected to the client computer. In this case too the thus produced target picture data are displayed by means of the client computer on the output device linked to the client computer. The advantage of the method first described above is that all internet users which access the internet pages stored on the server will receive a picture scaled according to the size of the output window of their client computer. No additional processing power or additional space in the client computer's memory is required on the side of the client computer in order to scale the received picture data. In particular, no additional program modules are required on the side of the client computer such as plug-ins for example. The advantage of the latter method is that an internet user can download any page of any internet server and the output picture will be scaled according to the window size on the desktop of the client computer. The display of internet pages stored on internet servers is thus enabled in any desired size.

The apparatus in accordance with the invention comprises one or several computer units and a main memory which is switched with the computer unit or units. The apparatus further comprises a storage medium and/or an area of the main memory with stored picture data and dimensional data of an output picture or a digital document and a storage medium and/or an area of the main memory with dimensional data of the desired output format of the target picture.

In accordance with the invention, a storage medium and/or an area of the main memory is provided with data of a scaling mechanism for scaling the output picture data. The apparatus in accordance with the invention further comprises a storage medium and/or an area of the main memory for storing target picture data. The scaling mechanism is stored in the storage medium or in the main memory so as to be executable in at least one computer unit and that it can receive the output picture data, scale them according to the dimensional data of the target picture and can save them as target picture data. The scaling mechanism comprises means for regularly checking or for advantageously permanently monitoring the dimensional data of the desired output format and for the renewed generation of the scaling factor and modified output picture data by a respective scaling of the dimensional data in output picture data in the case of changed dimensional data of the desired output format.

The apparatus in accordance with the invention comprises a display apparatus which is designed in such a way that it visualizes a picture composed of pixels according to the target picture data. This can be a tube screen, an LCD display, a TFT screen, a printer and/or a projector. It is understood that other pixel-oriented output devices are also possible.

As a result of the method in accordance with the invention and the apparatus in accordance with the invention it is possible for the first time with a minimum of effort to display a picture composed of pixels in a complete way and with any desired size on a pixel-oriented apparatus. A scaling of an output picture can occur especially advantageously by means of an internet server or a scaling mechanism for scaling the output picture data by a computer unit that can be stored in an executable way in a memory of an internet server. On the one hand, this allows any number of internet users to download internet pages from the internet server by means of their client computers and to display the same scaled to any desired size by means of their output apparatus. On the other hand, the scaling can occur by means of a client computer or the scaling mechanism is stored in the memory of the client computer so as to be executable by the computer unit of the client computer. As a result, an internet user can download internet pages from any internet server by means of his or her client computer and can display the same scaled to any desired size by means of his or her output device.

Especially the method or apparatus explained first allows displaying the pictures on the output units of the client computers in any desired size without requiring additional capacity in the main memory or additional processing power of the computer unit of the client computer as compared with the former display of a non-scaled picture. In particular, no plug-in is required for an internet browser installed on the client computer.

The method in accordance with the invention as well as the apparatus in accordance with the invention are also suitable to display a picture which is composed of pixels and whose output picture data are stored in a storage medium of a single computer apparatus, in particular a PC, as a target picture completely in any random size on the output device of the computer. Any digital document which is stored on the computer or a linked storage medium such as a CD is hereby mentioned as an output picture which is to be displayed on the desktop of the computer by means of a browser. By changing the size of the window frame of the browser it is possible to predetermine new dimensional data. The output picture data are then processed according to the method in accordance with the invention or by means of the scaling mechanism of the apparatus in accordance with the invention and stored as target picture data in a storage medium. A target picture according to the target picture data will be displayed on the output device. Changing the size of the window frame can occur especially by means of a mouse connected to the computer and/or a key combination or the push of a button of a keyboard connected to the computer. Other graphical input devices are also suitable, e.g. a trackball, a lightpen or a drawpad. In addition or alternatively it is possible to provide hardware and/or software for entering voice commands in order to enable voice control.

Embodiments of the apparatus and method in accordance with the invention are explained below and described in closer detail by reference to the drawings, wherein:

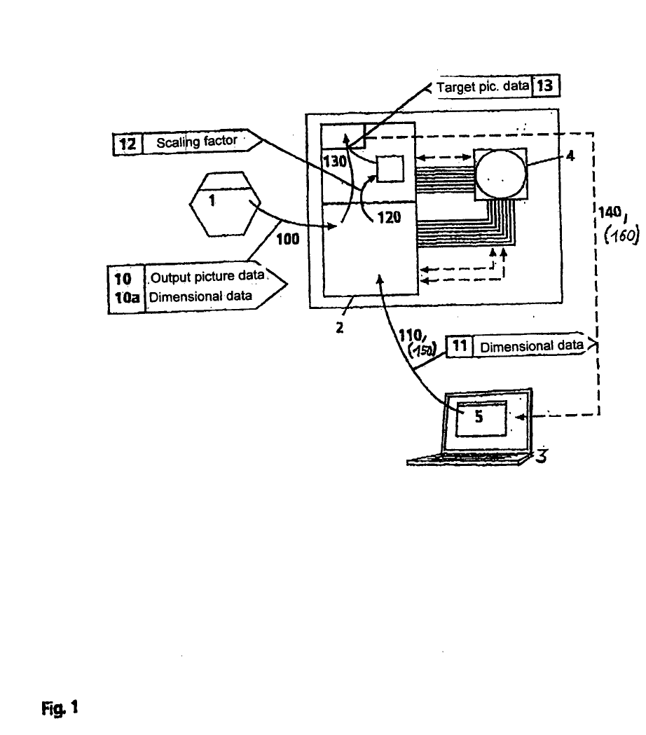

FIG. 1 shows an embodiment of the method in accordance with the invention;

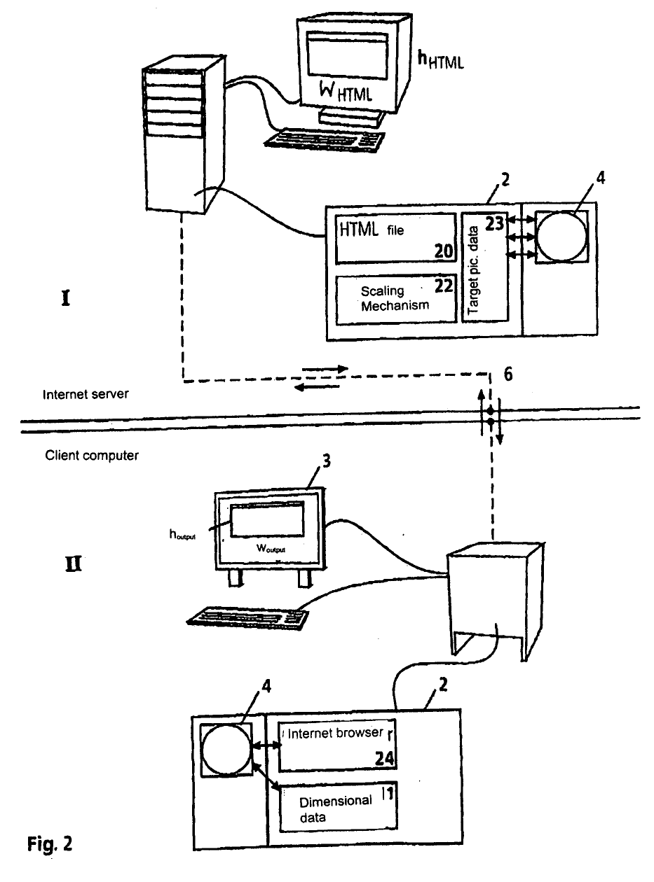

FIG. 2 shows an embodiment of the apparatus in accordance with the invention;

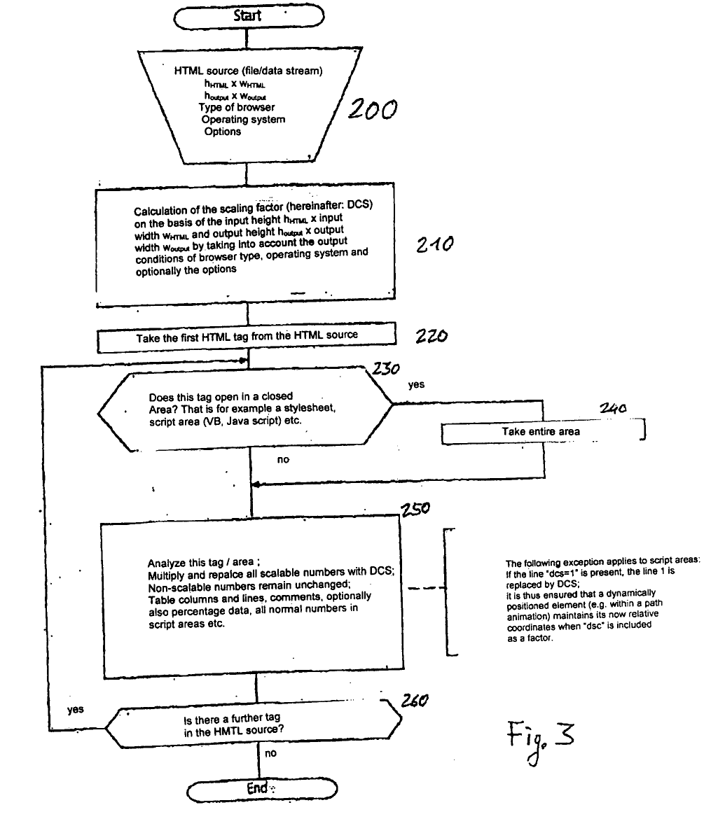

FIG. 3 shows a flow chart of a special embodiment of the method in accordance with the invention with scaling on the internet server side;

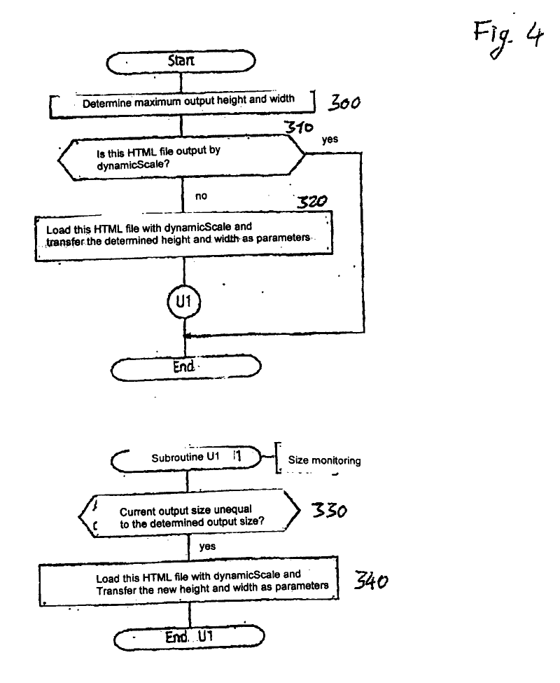

FIG. 4 shows an embodiment of the method in accordance with the invention in which the scaling can occur on the internet server side or on the client computer side;

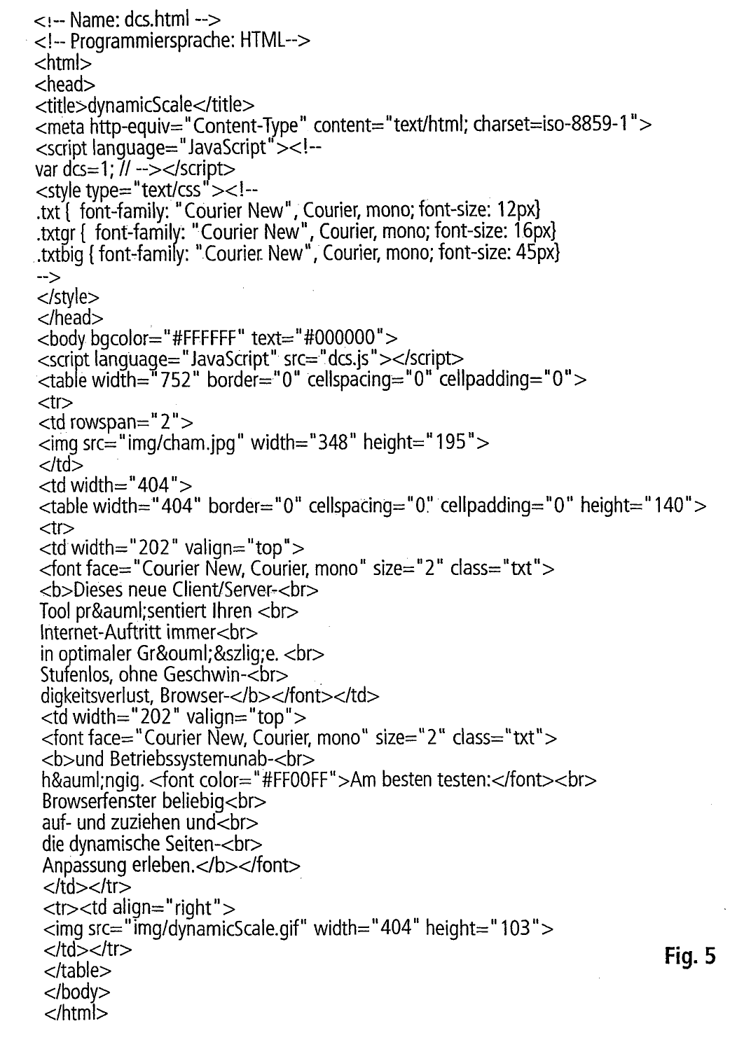

FIG. 5 shows an example of an internet page which was produced by means of HTML and can be scaled with the method in accordance with the invention or the apparatus in accordance with the invention;

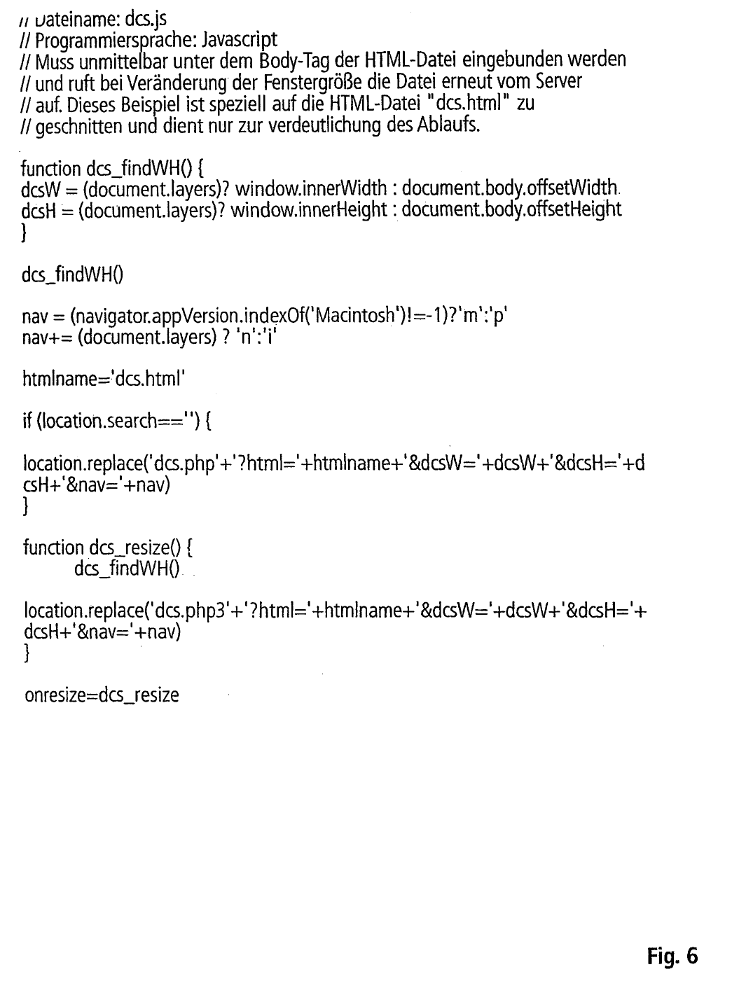

FIG. 6 shows a JavaScript source file which can also be included in the HTML file of the internet page to be displayed for the purpose of regular monitoring of the currently predetermined output dimension of the target picture;

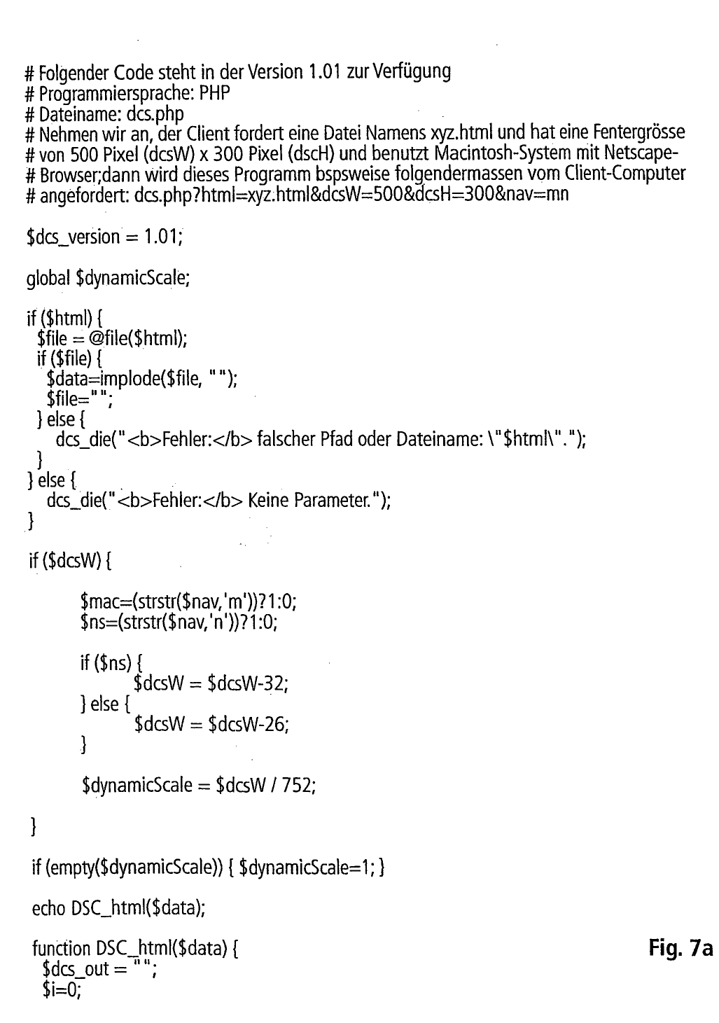

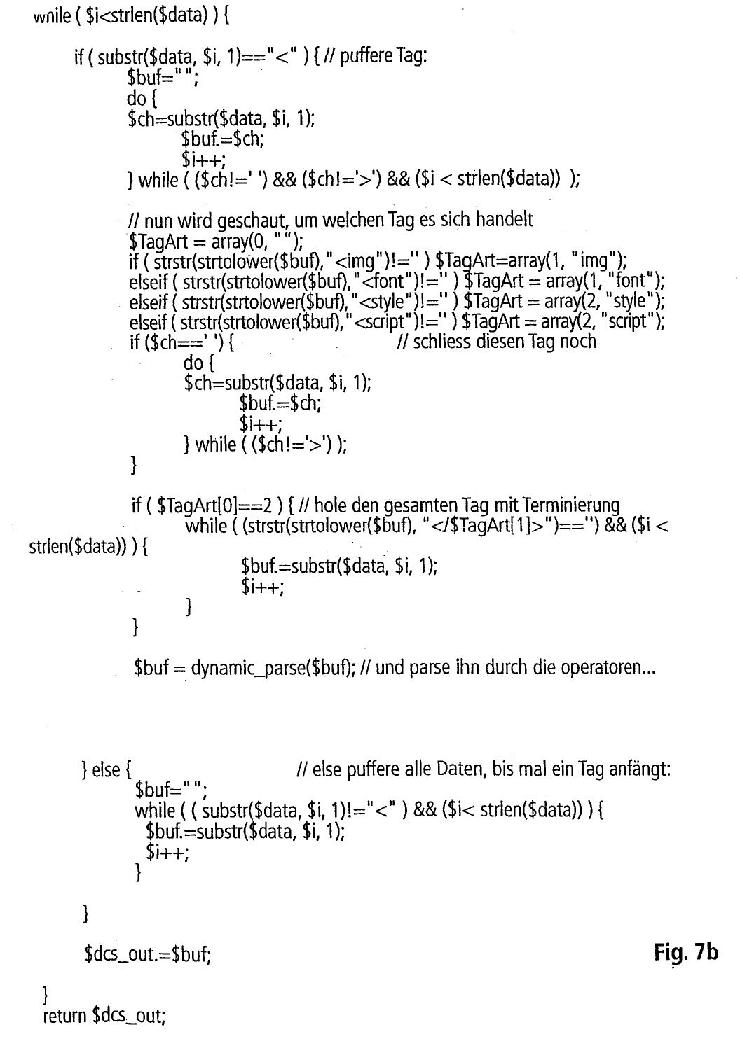

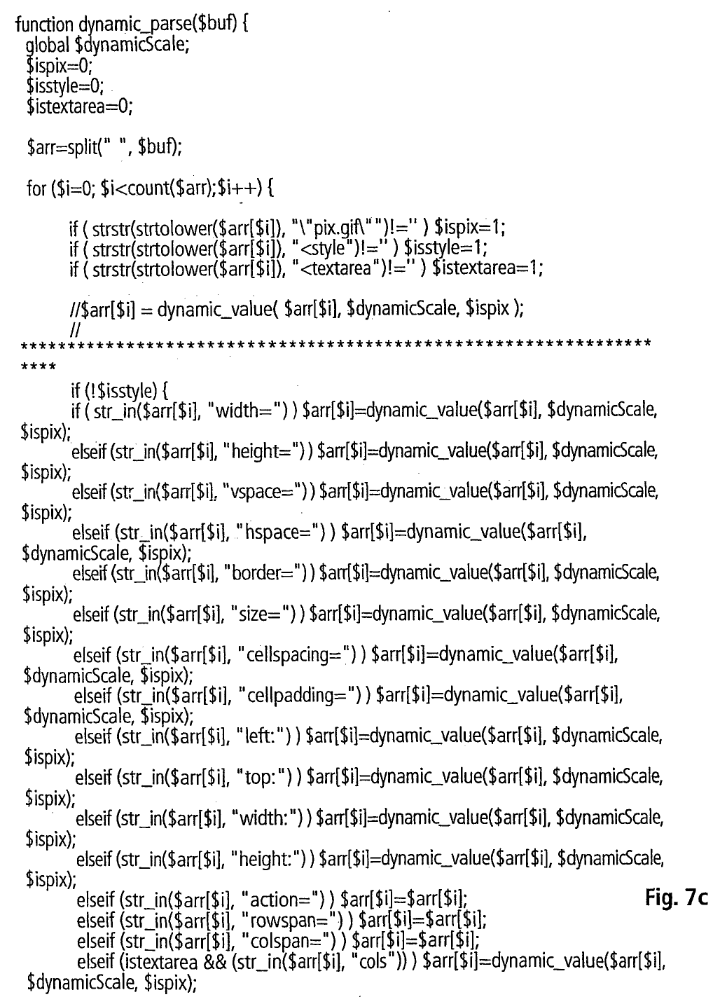

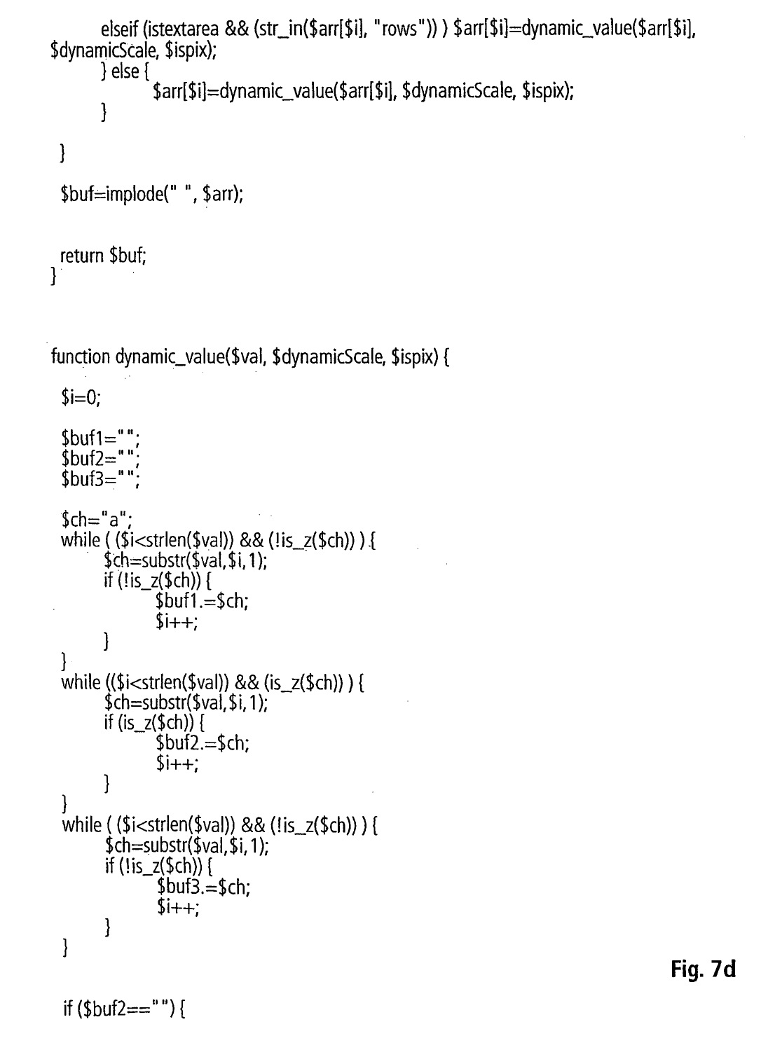

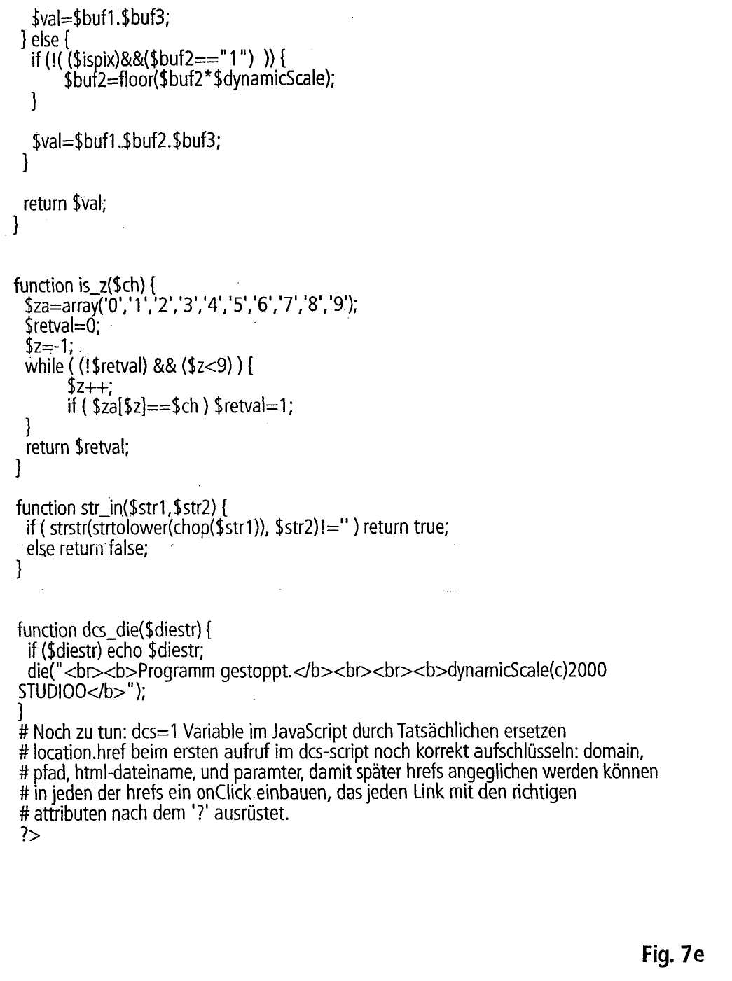

FIG. 7 shows an embodiment of a scaling mechanism in accordance with the invention;

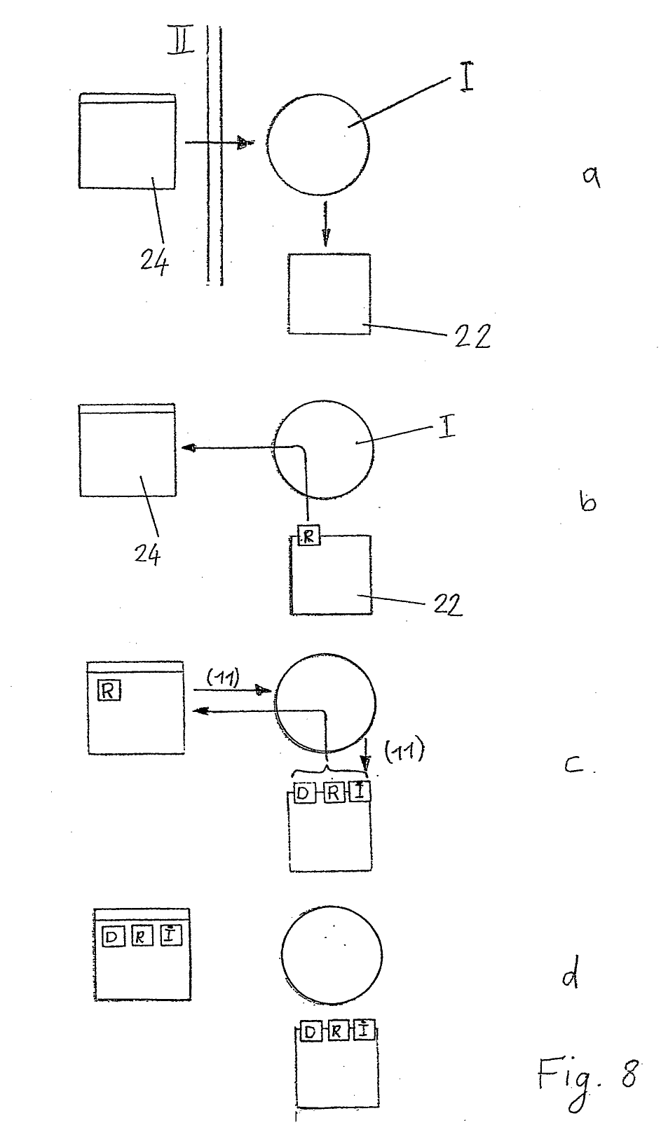

FIG. 8 shows the method as executed by the scaling mechanism;

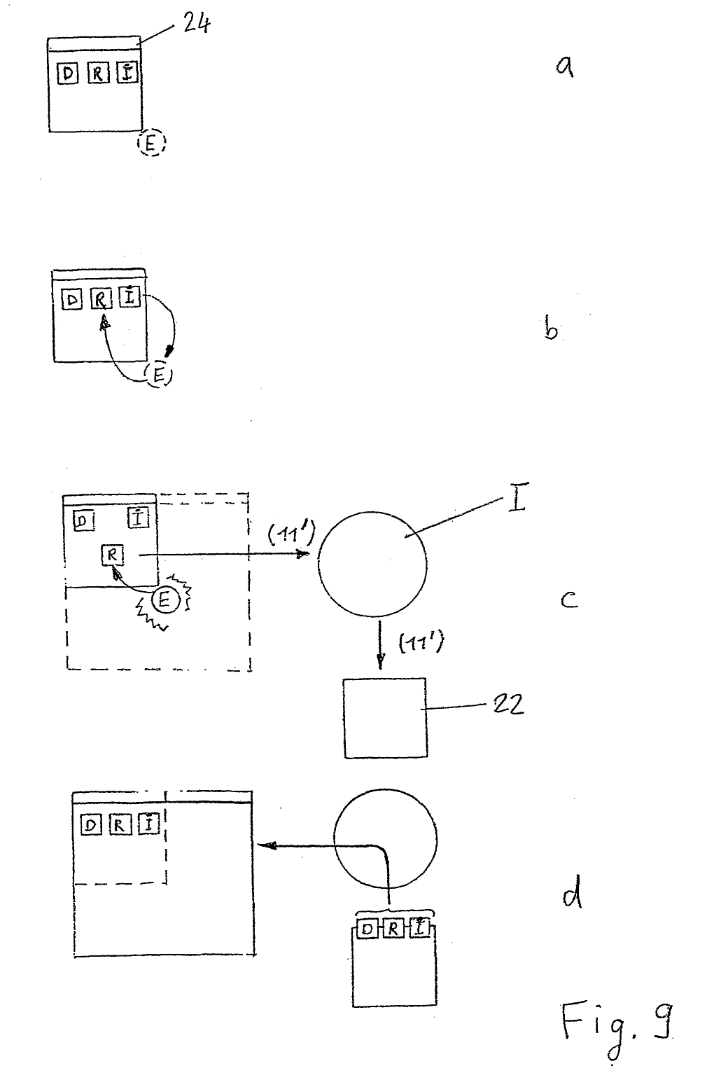

FIG. 9 shows the method when changing the size of a browser window of a browser with integrated recognition of change in the size;

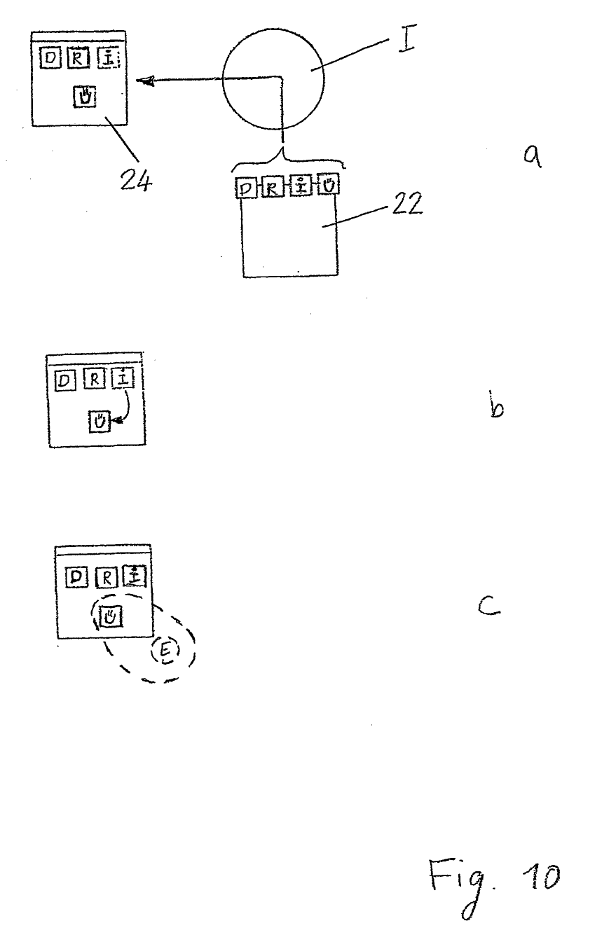

FIG. 10 shows the method when changing the size of a browser window of a browser without integrated recognition of change in the size.

FIG. 1 shows a method in accordance with the invention for displaying a picture 5 composed of pixels on a pixel-oriented output device 3. The picture 5 is the graphical implementation of a digital document (output picture) with output picture data 10 which comprise dimensional data 10a which are responsible for displaying the digital document in a predetermined size as a target picture on the output device 3. The output picture data 10 with the dimensional data 10a are read in a step 100 from a digital storage medium 1 into a main memory 2. In a step 110, the dimensional data 11 of the desired output format are read from a digital storage medium (not shown explicitly) into the same main memory 2. The dimensional data 10a of the output picture and the dimensional data 11 of the target picture are processed by means of the computer unit 4 which is interconnected to the main memory 2 and a scaling factor 12 (step 120) is generated depending on said dimensional data 10a, 11. Furthermore, the output picture data 10, i.e. all scalable variables in the output picture data 10, are multiplied with the scaling factor 12 by means of the computer unit 4 and stored as target picture data 13 in the main memory 2 (step 130). Finally, the target picture data 13 are sent to the output device 3 and the target picture is displayed on the output device 3 according to the target picture data 13 (step 140). It is also possible to intermediately store the target picture data 13 first in a further storage medium, e.g. the main memory of a client computer.

In predetermined intervals, the dimensional data 11 of the desired output format of the target picture are checked and in the case of changed dimensional data 11 the illustrated steps 120 to 140 will be repeated.

FIG. 2 shows an embodiment of an apparatus in accordance with the invention. One can see an internet server I and a client computer II. Both the internet server I as well as the client computer II comprise a computer unit 4 which is interconnected to a main memory 2. The client computer II comprises an output apparatus by means of which an internet page which is stored in the main memory of the internet server I as an HTML file with the output picture data 10 is to be displayed completely in a random size. The HTML file comprises the dimensional data 10a of the output picture, i.e. the size information in order to display the HTML file as a target picture in a pertinent size. The dimensional data 11 of the desired output format of the target picture are stored in the main memory 2 of the client computer. Data are exchanged between the internet server I and the client computer II by means of an internet link 6. The link 6 can be any kind of communications link or any desired communications mechanism. The protocols used for data transmission can be configured as standard protocols or even have a special form. It is understood that it is also possible that internet server I and/or the client computer II are additionally interconnected with one or several local networks (Local Area Network LAN) or are interconnected with other computers.

A scaling mechanism 22 is stored in the main memory 2 of the internet server. The scaling mechanism 22 is stored in such a way that it can be executed by the computer unit 4, such that it can receive the output picture data 10 of the HTML file, scale the same according to the dimensional data 11 of the target picture and can store the same as target picture data 13 in the main memory 2 of the internet server. Internet server I and client computer II are interconnected by means of the internet link in such a way that the target picture data 13 can be transmitted from the main memory 2 of the internet server I to the client computer II and that the output device 3 of the client computer II displays a picture composed of pixels according to said target picture data 13.

The display of the picture according to target picture data 13 preferably occurs by means of an internet browser 24 which is stored in an executable manner by the computer unit 4 in the main memory 2 of the client computer. Preferably, the dimensional data 11 of the target picture 11 comprise an output height hₒᵤₜₚᵤₜ and an output width wₒᵤₜₚᵤₜ and the dimensional data 10a of the output picture described by the HTML file comprises an output picture width w_{HTML} and an output picture height h_{HTML}.

The display apparatus or output device 3 of the client computer as represented in this embodiment comprises an LCD display. Other output apparatuses are also possible which display in a pixel-oriented fashion. The internet server I preferably also comprises an output device by means of which the output picture can be displayed.

It is understood that it is also possible that the output picture data 10, target picture data 13 and/or the scaling mechanism 22 are stored additionally or alternatively in a storage medium other than the main memory 2. Possible are both random read-only storage media (for the output picture data and the scaling mechanism) as well as all readable and rewritable storage media (for output and target picture data, scaling mechanism). Harddisks, CDs, DVDs and memory chips are hereby mentioned by way of example.

FIG. 3 shows a flow chart of a method in accordance with the invention. At first the output picture data which comprise an HTML source, the dimension of the output picture h_{HTML}×w_{HTML}, the target picture data which comprise the dimension of the target picture hₒᵤₜₚᵤₜ×wₒᵤₜₚᵤₜ, the type of browser by means of which the picture will be displayed on the output device, the operating system which is installed on the client computer in particular, and especially further options concerning the desired output are read into the main memory (step 200).

Then a scaling factor (DCS) is calculated, namely on the basis of the input height h_{HTML}×input width w_{HTML} and output height hₒᵤₜₚᵤₜ×output width wₒᵤₜₚᵤₜ by taking into account the output conditions, and the type of browser in particular, the operating system and optionally certain options (step 210).

The first HTML tag is then read from the HTML source (step 220) and it is checked whether this tag comprises a data block with an inherently closed area or whether a closed area opens in this tag (e.g. a stylesheet, a script area (VB, Java script or the like) (step 230).

If a closed area opens in the read tag, the entire area is read into the main memory (step 240). If no closed area opens in the read tag, step 240 is skipped and step 250 occurs directly in which the read tag or the entirely read area is analyzed and all scalable numbers are multiplied with the scaling factor and replaced by the result. The non-scalable numbers or variables remain unchanged. Examples for this are table columns and lines, comment fields, optionally percentage rates, all normal numbers in the script area, i.e. numbers which are displayed in a text field for example.

It is then checked in step 260 whether the HTML source comprises a further, as yet unread tag and, if yes, steps 230 to 260 are repeated.

In particular, step 250 comprises an exception in order to ensure that also a dynamically positioned element within the HTML source is displayed in a dimension which is correct relative to the target picture. This exception can be activated or marked in such a way that the scaling factor is set to 1 in the script area of the internet page (DCS=1).

The method as shown in FIG. 3 is especially suitable for a scaling on the server side, i.e. the data processing which comprises the calculation of the scaling factor and the generation of the target picture data occurs by means of a computer unit of the internet server and the data are stored in the main memory of the internet server. This allows that the dimensional data of the target picture are queried by the client computer in one step by means of the computer unit of the internet server, meaning that the computer unit of the client computer is used to send via the internet link a response concerning the dimensional data of the target picture to the internet server. In an especially advantageous embodiment this step can be omitted, namely in the case when the computer unit of the client computer sends the dimensional data of the target picture to the internet server by means of an internet browser which is installed on the client computer already directly when accessing the internet page which is stored on the internet server.

FIG. 4 shows a method in accordance with the invention which is also especially suitable for scaling on the client side, i.e. in which processing steps for the scaled display of the target picture can occur by means of the computer unit of the client computer. At first the output height and/or output width of an internet page read from an internet page is determined (step 300). It is then checked whether this internet page (especially in the format of an HTML file) has already been scaled by means of the internet server by means of a method in accordance with the invention to the desired target picture size (step 310), i.e. it is checked whether this internet page was sent by a scaling mechanism in accordance with the invention (dynamicScale). If this is the case, no scaling needs to occur on the client side. The process is already completed. If this is not the case, step 320 occurs in which the internet page, and the HTML file in particular, is scaled by means of the method in accordance with the invention, especially by executing the steps 200 to 260 of FIG. 3. This scaling can occur by means of the computer unit of the client computer. It is understood, however, that scaling can also occur by means of the computer unit of the internet server.

It is then especially advantageously checked whether the desired output dimension of the target picture has already changed again, i.e. whether the current output size is unequal to the determined output size (step 330). If the desired output size has already changed again, the new height and width are determined as parameters and the method in accordance with the invention is applied again, especially by executing the steps 200 to 260 of FIG. 3 (step 340).

FIG. 5 shows an example of an internet page which has been prepared by means of HTML and which can be scaled with the method in accordance with the invention or with the apparatus in accordance with the invention. As can be seen, various picture elements and text elements are incorporated in the internet page. This internet page can be stored in a storage medium of an internet server and can be retrieved by means of a link via the internet from a client computer and can be displayed by means of an output device. The internet page as described in FIG. 5 has a fixed picture size which can be obtained from the size variables shown in FIG. 5. Reference is hereby made to the 27^{th} line in which a picture element (scr=“img/cham.jpg”) is incorporated in the internet page with a fixed width of 348 pixels (width“348”) and a height of 195 pixels (height=“195”). The size of the output picture as determined by the individual elements can be displayed completely and in a dimensionally accurate fashion with respect to the output picture by means of the invention in any desired size according to the desired format of the output device or according to the dimensional data of the target picture.

FIG. 6 shows a JavaScript source file which can be included in the HTML file of the internet page to be displayed. In particular, it can be incorporated directly under the body tag of the HTML file. The represented JavaScript source file is an example for the execution of an advantageous inventive method step for monitoring or checking in a predetermined time interval whether the desired output dimension of the target picture has changed (according to the step 330 as described in FIG. 4).

FIG. 7 shows an embodiment of a scaling mechanism in accordance with the invention. This scaling method can be executable by a computer unit (CPU) especially in the main memory (RAM) of an apparatus for displaying a picture composed of pixels, especially an internet page. The scaling mechanism as described in FIG. 7 is capable, when executed by the computer, of receiving the data of an output picture, and in particular—as described in FIG. 7—the tags of an internet page as stored in HTML, of scaling them according to the method in accordance with the invention and of storing them as target picture data in the main memory in particular. The target picture data can then be visualized by means of a display apparatus.

FIG. 8 shows in an embodiment again how the scaling mechanism 22 in accordance with the invention works. FIG. 8a shows a state in which a browser 24 which is executed on a client computer II sends a request for a digital document to a server I. The server I sends the queried data, i.e. the requested digital document, through the scaling mechanism 22. The scaling mechanism 22 checks the data as sent by the server I (FIG. 8b) and recognizes that no dimensional data of the desired output format is present. Thereupon the scaling mechanism 22 sends the script R to the browser 24 in order to determine the dimensional data of the desired output format.

The script R is executed by the browser 24 or by the client computer II on which the browser is being executed and ensures that the digital document is requested again from server I (FIG. 8c). This time the request contains the dimensional data 11 of the desired output format. The scaling mechanism 22 recognizes the dimensional data 11 and re-scales the digital document accordingly. The modified digital document D is sent to the browser 24 together with the script R and a further script i whose function will be explained later in closer detail. Browser 24 shows the document D in a browser window with the previously sent dimensional data 11.

Every further document is requested as shown in FIG. 8c, because the dimensional data 11 are now known because the script R was incorporated in the browser in an executable fashion (FIG. 8d).

An advantageous function of the method in accordance with the invention in the case of a change in the size of the browser window will be explained below. One must distinguish between two cases, namely whether the browser 24 has an internal function which automatically recognizes a change in the size of the browser window (FIG. 9) or whether the browser 24 does not have such a function (FIG. 10).

The browser 24 as shown in FIG. 9 has a function which continually monitors the size of the browser window, recognizes a change in the size of the window and automatically initiates an event E in the case of a change. As a result of the script i sent with the document, the scaling mechanism 22 ensures that the document, once it has been set up completely, starts an initialization routine (script i), i.e. the script i is executed by the browser 24 and is incorporated in the browser 24 in a manner so as to be executed (FIG. 9a).

The script i then ensures that the event E when activated initiates the script R (FIG. 9b). It can therefore be said that the event E has been “bent” in such a way that in the case of a change in the dimension of the browser window the digital document is requested again with a request comprising the new dimensional data 11′ (FIG. 9c). A digital document which is respectively newly scaled by the scaling mechanism 22 is sent by the server I subsequently to the client computer II and displayed by means of the browser in the new dimension (FIG. 9d).

FIG. 10 shows the case in which the browser does not have an internal function which recognizes the change in size of the browser window. In this case the scaling mechanism 22 transmits with the digital document not only the scripts R, i, but also a further monitoring script U to the browser 24 which is running on the client computer II (FIG. 10a). During the initialization by executing script i, this monitoring script Ü is activated (FIG. 10b). The executed monitoring script Ü now simulates the event E and it can be continued, as shown in FIG. 9.

The process sequence as described above shows in particular that the invention ensures with especially simple means that a digital document is displayed dynamically and in a manner so that its size can be changed at any time by the user on the desktop of a computer. The invention makes use of properties of conventional programs in order to achieve efficient dynamics in the display with a low amount of programming efforts and with a low amount of use of storage capacity. Many conventional browsers contain a so-called Document Object Model (DOM). The DOM can be configured in many different ways and contains properties and functions which can be read out or executed via script languages or programs which extend the functionality of the browser.

These properties are utilized by the scaling mechanism in accordance with the invention, such that especially advantageously the width and height information of the current display area is read out in order to enable the determination of the dimensional data of the desired output format. If such information is present, the scaling mechanism in accordance with the invention also uses the “resize” function.

A server waits for the request from a client which is usually executed by a browser running on the client computer and compiles respective data according to this request and sends them to the client. This is used for the purpose in accordance with the invention that the scaling mechanism is activated in this send path, so that data can be modified accordingly before they reach the client. The functionality of the server can also be extended by script languages and/or programs. The scaling mechanism can be regarded as such a program or script which extends the functionality of the server.

As already explained above, the scaling mechanism can also be executed on a proxy server, wherein the said proxy server can be simulated by software on an internet server or can also be an independent physical module with respective hardware. When the scaling mechanism is embedded in a server (e.g. an internet server) the scaling mechanism per se can also be designated as a server.

The most relevant functions or work steps of an advantageous execution of the scripts used will be described below:

The script R determines the dimensional data of the desired output format, determines further which document is currently demanded and produces a request for this document, with the request comprising the determined dimensional data.

The script Ü monitors the dimensional data of the browser window in a regular interval, and especially continuously, when the browser does not have such a function. In the case of a difference of the dimensional data there is a notification or the event is simulated or activated.

The script i is used for an initialization routine which in the case of a respective functionality of the browser either ensures that the script R is executed when event E occurs or which ensures that the monitoring script Ü is activated which simulates such an event E.

An embodiment for the claimed computer system consists (as shown in FIG. 2) in an especially simple embodiment of an internet server I and a client computer II which are mutually linked via an internet connection 6.

As shown in FIG. 2, the claimed server system can be arranged as an internet server I and the client system as a simple client computer II.

Examples of digital storage media are RAM chips, ROM chips, optical, magnetic or magneto-optical data media (CD, DVD, etc.) as well as generally static, dynamic, volatile or non-volatile storage devices.

### List of Reference Numerals

1 Storage medium

2 Main memory

3 Output device

4 Computer unit

5 Picture

6 Internet connection

10 Output picture data

10a Dimensional data of digital document

11 Dimensional data of desired output format

12 Scaling factor

13 Target picture data

22 Scaling mechanism

24 Browser

I Internet server

II Client computer

D Document

R Script

i Script

Ü Monitoring script

1. A method for the size-adjusted display of a digital document on a pixel-oriented output device (3), comprising the following steps:
1.1 the output picture data (10) of the digital document to be displayed (output picture) which are stored in a digital storage medium (1) and comprise predetermined dimensional data (10a) for displaying the digital document in a predetermined size are read into a main memory (2) (100);
1.2 the dimensional data (11) of the desired output format of the digital document to be displayed on the output device (3) as a target picture, with the dimensional data being stored in the storage medium, are read into the main memory (2) (110);
1.3 the predetermined dimensional data (10a) of the digital document and the dimensional data (11) of the desired output format are processed by means of at least one computer unit (4) interconnected with the main memory (2) and a scaling factor (12) is produced depending on said dimensional data (120);
1.4 the predetermined dimensional data (10a) in the output picture data (10) are multiplied with the scaling factor (12) by means of the computer unit (4) and the thus modified output picture data (10) are stored as target picture data (13) in the main memory (2) or any other storage medium (130);
1.5 the target picture data (13) are transmitted to the output device (3) and the digital document is displayed according to the target picture data (13) on the output device (3) (140);
1.6 the dimensional data (11) of the desired output format are checked recurrently in intervals (150);
1.7 in the case of changed dimensional data (11) the scaling factor (12) is newly generated and the target picture data (13) are newly calculated according to step 1.4 and the digital document is displayed again according to step 1.5 (160).

2. A method as claimed in claim 1, characterized by the following features:
2.1 the output picture data (10) are stored on a server, especially an internet server (I);
2.2 the dimensional data (11) of the desired output format are stored on a client computer (II);
2.3 the display of the digital document on an output device (3) of the client computer (II) occurs by means of a browser (24) which is executed on the client computer and displays the digital document in a browser window, with the dimensional data (11) of the desired output format corresponding to dimensional data of the browser window;
2.4 the browser (24) sends a request to the server in order to receive the digital document from the server;
2.5 the server sends the output picture data (10) of the digital document through a scaling mechanism (22) which is stored in an executable manner on the server in the form of a script or program;
2.6 the scaling mechanism (22) checks whether the request of the browser (24) comprises the dimensional data (11) of the desired output format;
2.7 when the request of the browser (24) does not comprise the dimensional data (11) of the desired output format, the scaling mechanism (22) sends a script (R) to the browser of the client computer which is executed by the browser, with the script (R) determining the dimensional data (11) and sending a renewed request for the digital document to the server, with the request comprising the determined dimensional data (11);
2.8 the scaling mechanism (22) produces the scaling factor (12), modifies the output picture data (10) according to step 1.4 and sends the target picture data (13) to the browser (24) of the client computer (II);
2.9 the scaling mechanism (22) sends in addition to the target picture data (13) the script (R) and a further script (i) to the browser (24) of the client computer (II), with the browser executing the script (i) and the script (i) causing that the script (R) is executed by the browser when changed dimensional data (11) of the desired output format have been established, with the script (R) determining the dimensional data (11) and sending a renewed request for the digital document to the server and with the request comprising the determined dimensional data (11).

3. A method as claimed in claim 2, characterized in that the browser (24) recognizes a change in the size of the browser window and, in response, initiates an event (E), with the script (i) initiating that the script (R) is executed by the client computer (II) upon occurrence of the event (E).

4. A method as claimed in claim 2, characterized in that in step 2.9 the scaling mechanism (22) additionally sends a monitoring script (Ü) to the browser (24) of the client computer (II), with the monitoring script (Ü) being activated by the script (i) and a change in the size of the browser window being recognized and, in response, initiating the execution of the script (R) by the client computer.

5. A method as claimed in one of the claims 2 to 4, characterized in that the digital document is stored on an internet server (I) and the scaling mechanism (22) is stored on a proxy server interconnected between the internet server (I) and the client computer (II) and is executed by the proxy server.

6. A method as claimed in one of the claims 1 to 5, characterized in that the digital document comprises the data of an internet page, especially an HTML file.

7. A method as claimed in one of the claims 1 to 6, characterized by the following features:
7.1 the output picture data (10) comprise the data of an internet page, especially an HTML file;
7.2 the dimensional data (11) of the desired output format comprise the window data of an internet browser (24);
7.3 the dimensional data (10a) of the digital document comprise the picture height (h_{HTML}) and the picture width (w_{HTML}) of the output picture;
7.4 the window data of the internet browser (24) comprise the height (hₒᵤₜₚᵤₜ) und die width (wₒᵤₜₚᵤₜ) of the picture area of the window;
7.5 the scaling factor (12) is produced depending on the picture height (h_{HTML}) and/or the picture width (b_{HTML}) of the output picture and the picture height (hₒᵤₜₚᵤₜ) and/or the picture width (wₒᵤₜₚᵤₜ) of the window picture area, especially depending on
h_{HTML}×w_{HTML} and hₒᵤₜₚᵤₜ×wₒᵤₜₚᵤₜ
or h_{HTML} and hₒᵤₜₚᵤₜ
or w_{HTML} and wₒᵤₜₚᵤₜ.

8. A method as claimed in claim 7, characterized by the following features:
8.1 the output picture data (10) are serially read into the main memory (2) in the form of data blocks, especially HTML tags;
8.2 the data block, and especially the HTML tag, is checked for scalable variables;
8.3 all scalable variables of the data block, and especially the HTML tag, are multiplied with the scaling factor (12) and replaced by the result of the multiplication;
8.4 the data block, and especially the HTML tag, is sent to the internet browser (24) and processed by means of the internet browser in such a way that the picture to be displayed is built up step by step.

9. A method as claimed in one of the claims 1 to 8, characterized by the following features:
9.1 the digital document is stored on an internet server (I);
9.2 the dimensional data (11) of the desired output format are read into the main memory of a client computer (II) from a storage medium, especially the main memory of the client computer (II);
9.3 the scaling factor (12) and the target picture data (13) are produced by means of the computer unit of the client computer (II) and stored in the main memory or any other storage medium of the client computer (II);
9.4 the target picture data (13) are displayed especially by means of an internet browser (24) installed on the client computer (II) on the output device (3) which is connected with the client computer (II).

10. A method as claimed in one of the claims 1 to 9, characterized in that the dimensional data (11) are produced by a computer unit (4) connected to the output device (3) immediately before the display depending on the desired output format, so that no permanent storage of the dimensional data (11) in a database occurs.

11. An apparatus for displaying a digital document as a target picture on a pixel-oriented output device (3), comprising:
11.1 at least one computer unit (4);
11.2 a main memory (2) which is interconnected with the computer unit (4);
11.3 a storage medium and/or an area of the main memory (2) with the stored output picture data (10) of the digital document, comprising predetermined dimensional data (10a) for displaying the digital document in a predetermined size;
11.4 a storage medium and/or an area of the main memory (2) with the dimensional data (11) of the desired output format of the target picture;
11.5 a storage medium and/or an area of the main memory (2) with the data of a scaling mechanism (22) for scaling the output picture data (10) of the digital document;
11.6 a storage medium and/or an area of the main memory (2) for storing the modified digital document as target picture data (13);
11.7 the scaling mechanism (22) is stored on the storage medium or in the main memory (2) in a manner so as to be executable by the computer unit (4), so that it can receive the output picture data (10) of the digital document, scale the same according to the dimensional data (11) of the target picture and can store them as target picture data (13), with the dimensional data (11) of the target picture being checked in intervals and with the output picture data (10) of the digital document being scaled again in the case of a change in the dimensional data (11) of the target picture and being saved as target picture data (13);
11.8 a display device (3) which is configured in such a way that it visualizes a picture composed of pixels according to the target picture data (13).

12. A computer system, comprising a server, in particular an internet server (I) on which a digital document is stored, and a client computer (II) which contains in an executable fashion a browser (24) for displaying the digital document as a target picture on an output device (3) connected to the client computer, characterized by the following features:
12.1 a scaling mechanism (22) is stored in an executable fashion on the server or on a proxy server which is interposed in addition between the server and the client computer, so that the digital document, when requested by the browser (24) of the client computer (II), is sent through the scaling mechanism, with a method according to one of the claims 2 to 10 being carried out.

13. A server system for producing or storing and for transmitting a digital document, especially an internet page to a client system, following a request for the digital document by the client system, comprising:
13.1 output picture data (10) of the digital document which are stored on the server system, comprising dimensional data (10a) of the digital document to be sent;
13.3 a scaling mechanism (22) which is stored in an executable fashion on the server system, through which the digital document is sent to the client system, characterized by the following features:
13.4 the scaling mechanism (22) comprises means for checking the request by the client system for dimensional data (11) of a desired output format and for detecting said dimensional data (11);
13.5 the scaling mechanism (22) further comprises means for initiating a new request for the digital document stored on the server system by the client system, comprising the dimensional data (11) of the desired output format when the first detected request does not comprise any dimensional data (11) of the desired output format;
13.6 the scaling mechanism (22) further comprises means for generating a scaling factor (12) depending on the dimensional data (10a) of the digital document and the detected dimensional data (11) of the desired output format and for producing a modified digital document with scaled output picture data depending on the output picture data (10) and the scaling factor (12), so that instead of the digital document stored on the server system the modified digital document is sent to the client system;
13.7 the scaling mechanism (22) comprises means for initiating a renewed request for the digital document stored on the server system by the client system, comprising the dimensional data (11) of the desired output format when the dimensional data (11) of the desired output format have changed.

14. A server system according to claim 13, characterized in that the server system comprises an internet server (I) on which the digital document is stored and a proxy server on which the scaling mechanism (22) is stored in an executable fashion.

15. A client system for displaying a digital document, especially an internet page, comprising:
15.1 means for receiving output picture data (10) of the digital document to be displayed, comprising dimensional data (10a) for displaying the digital document in a predetermined size;
15.2 an output device (3) for displaying the digital document;
15.3 a size-variable target picture area on the output device (3) in which the digital document will be displayed as a target picture, comprising dimensional data (11) of the desired output format;
15.3 a scaling mechanism (22) which is stored in an executable fashion on the client system and through which the digital document is sent;
15.4 means for displaying the digital document as a target picture on the output device (3) in the size-variable target picture area, characterized by the following features:
15.5 the scaling mechanism (22) comprises means for detecting the dimensional data (11) of the desired output format;
15.6 the scaling mechanism (22) comprises means for producing a scaling factor (12) depending on the dimensional data (10a) of the digital document and the detected dimensional data (11) of the desired output format and for producing a modified digital document with scaled output picture data depending on the output picture data (10) and the scaling factor (12), so that instead of the originally received digital document the modified digital document is displayed on the output device (3);
15.7 the scaling mechanism (22) comprises means for initiating a renewed generation of a scaling factor (12) depending on the dimensional data (10a, 11) of the digital document and the desired output format and a renewed generation of a modified digital document with scaled output picture data depending on the output picture data (10) and the scaling factor (12), so that a renewed display of the modified digital document on the output device (3) is performed when the dimensional data (11) of the desired output format have been changed.

16. A computer program with program code means in order to perform a method according to one of the claims 1 to 10 when the program is executed on a computer.

17. A computer program product with program code means which are stored on a computer-readable data medium in order to perform a method according to one of the claims 1 to 10 when the program product is executed on a computer.

18. A digital storage medium with a data structure with electronically readable control signals which can cooperate with a programmable computer system in such a way that a method according to one of the claims 1 to 10 is performed.

19. A data structure with electronically readable control signals which can cooperate with a programmable computer system in such a way that a method according to one of the claims 1 to 10 is performed.
